(19) United States
(12) Patent Application Publication
(10) Pub. No.: US 2013/0343429 A1
(43) Pub. Date: Dec. 26, 2013

(54) Temperature measuring apparatus, measuring element for a temperature measuring apparatus and method for manufacturing the temperature measuring apparatus

(71) Applicant: Endress + Hauser Wetzer GmbH + Co. KG, Nesselwang (DE)

(72) Inventors: Helmut Kalteis, Marktoberdorf (DE); Peter Seefeld, Pfronten (DE)

(21) Appl. No.: 13/925,901

(22) Filed: Jun. 25, 2013

Related U.S. Application Data
(60) Provisional application No. 61/664,219, filed on Jun. 26, 2012.

(30) Foreign Application Priority Data
Jun. 26, 2012 (DE) 102012105547.5

(51) Int. Cl. G01K 7/02

(52) U.S. Cl. CPC G01K 7/02
USPC 374/179; 29/592.1

(57) ABSTRACT

A temperature measuring apparatus comprising at least one measuring element, a jacket, in which the measuring element is arranged, wherein the measuring element includes a thermocouple, which is composed of at least two thermocouple wires connected with one another at a height of a measuring point along the longitudinal axis of the jacket. The thermocouple wires extend a first distance along the longitudinal axis of the jacket at least up to the measuring point, and wherein the measuring element includes, furthermore, at least two connection wires, which extend a second distance on the side of the measuring point lying opposite the thermocouple wires along the longitudinal axis of the jacket and are connected with the thermocouple wires, wherein the two connection wires are composed of a material, which differs from that of the thermocouple wires.

### CROSS-REFERENCE TO RELATED APPLICATION

This application is a nonprovisional which claims the benefit of U.S. Application Provisional Application 61/664,219, which was filed on Jun. 26, 2012.

### TECHNICAL FIELD

The invention relates to a temperature measuring apparatus, a measuring element for such a temperature measuring apparatus and a method for manufacturing the temperature measuring apparatus.

### BACKGROUND DISCUSSION

Various measuring principles are known for measuring temperature, for example, temperature in an industrial plant. Frequently, thermocouples are used, in order to detect temperature gradients between a location in a process and the process environment. The state of the art shows many such apparatuses, in the case of which, for example, a number of thermocouples are arranged in a jacket serving as protective tube.

These solutions known from the state of the art have, however, the disadvantage that they exhibit, in the case of the drawing process, in which the jacket and thermocouples are lengthened, a high susceptibility for defects and a lack of reproducibility. The drawing process occurs, in such case, for example, by application of pressure or, generally, by mechanical working and deforming of the jacket and the therein arranged thermocouples. Furthermore, the material, from which the thermocouples are made, is often expensive in comparison to other electrical conductors.

### SUMMARY OF THE INVENTION

In view of these disadvantages, it is an object of the invention to provide a robust temperature measuring apparatus, which has, compared with solutions known from the state of the art, at least equal thermal resistance and mechanical strength and which also withstands the increased mechanical loading of a manufacturing related, drawing process.

The object is achieved according to the invention by a temperature measuring apparatus, a measuring element and a method for manufacturing the temperature measuring apparatus.

As regards the temperature measuring apparatus, the object is achieved by a temperature measuring apparatus comprising at least one measuring element, wherein the temperature measuring apparatus has a jacket, preferably a cylindrical jacket, especially preferably a metal jacket, in which the measuring element is arranged. The jacket serves, in such case, mainly for protecting the measuring element against a measured material, whose temperature is to be determined by the measuring element.

The measuring element includes, in such case, at least one thermocouple, which is composed of at least two thermocouple wires. For example, a thermocouple can be used, which is composed of only two thermocouple wires. On the other hand, also thermocouples are known, which are composed of more than two thermocouple wires.

Furthermore, the thermocouple wires are connected with one another at a height of a measuring point along the longitudinal axis of the jacket. The measuring point forms, in such case, the position, at which the temperature present in the process is determined. In such case, the temperature difference between the measuring point and the process environment is determined. This measuring point can be located, in such case, at a certain height of the jacket of the temperature measuring apparatus. Preferably, exactly one measuring point is arranged at a predetermined height along the longitudinal axis of the jacket.

The thermocouple wires of the temperature measuring apparatus extend a first distance along the longitudinal axis of the jacket at least up to the measuring point. In such case, the thermocouple wires can extend, for example, along the longitudinal axis of the jacket and essentially parallel to the longitudinal axis and to one another.

The temperature measuring apparatus, respectively the measuring element, includes, furthermore, at least two connection wires, which extend a second distance on the side of the measuring point lying opposite the thermocouple wires along the longitudinal axis of the jacket and are connected with the thermocouple wires. These two connection wires form, thus, a lengthening of the thermocouple wires.

Preferably, the jacket has a floor and the distance between the end of the thermocouple wires and the floor forms, in such case, the second distance along which the two connection wires extend. The connection wires extend, in such case, essentially to the floor, or to a region of the jacket adjoining the floor.

Furthermore, the two connection wires are composed of a material, which differs from that of the thermocouple wires. The at least a first thermocouple wire and the at least a second thermocouple wire, of which the thermocouple is constructed, are composed, in such case, of different materials. The material of the connection wires differs from the material used for the at least a first and the at least a second thermocouple wires.

In a form of embodiment of the temperature measuring apparatus, the thermocouple wires serve for determining temperature, wherein between the ends of the thermocouple wires a voltage is tappable corresponding to the temperature at the measuring point. The connection wires form, in such case, “blind elements”, which serve essentially only for the manufacturing process of the temperature measuring apparatus. The connection wires have, in such case, no influence on the temperature present at the measuring point, respectively the voltage tappable between the ends of the thermocouple wires.

In an additional form of embodiment of the temperature measuring apparatus, the connection wires extend on the side of the measuring point lying opposite the thermocouple wires and are connected with the thermocouple wires. Preferably, the connection wires are connected with the thermocouple wires on the oppositely lying side of the measuring point. The combination of the thermocouple wires and the connection wires extends preferably essentially over the entire length of the jacket. Furthermore, the thermocouple wires are, in such case, preferably so arranged that their free ends are located outside of the jacket, so that these free ends are contactable and a voltage between them can be tapped, which corresponds to the temperature at the measuring point.

In an additional embodiment of the temperature measuring apparatus, the thermocouple wires have, in each case, a first section, which extends up to the measuring point and, furthermore, in each case, a second section, which extends between the measuring point and the connection wires. The thermocouple wires are thus connected with one another at the measuring point, but extend yet further along the longitudinal axis of the jacket, in order then to be connected with the connection wires. The first distance, along which the thermocouple wires extend, is composed thus of a first section which extends up to the measuring point and a second section which starts from the measuring point and forms a further piece of the first distance.

In an additional form of embodiment of the temperature measuring apparatus, the connection wires, respectively the material of which the connection wires are composed, have a higher tensile strength than the thermocouple wires, respectively the material of which the thermocouple wires are composed. As already mentioned, the at least a first thermocouple wire and the at least a second thermocouple wire, of which the thermocouple is constructed, are composed of different materials. The connection wires can be either of the same material or of different materials. However, the material of which the connection wires are composed differs from the material, of which the thermocouple wires are composed, at least in that the material of which the connection wires are composed has a higher tensile strength than the respective materials of which the thermocouple wires are composed. The tensile strength is, in such case, the stress, which is determined in a tensile test from the maximum calculated tensile force divided by the original cross section of the wires. Serving as unit of measurement for the tensile strength, in such case, is, for example, the newton per mm² or the megapascal.

In a form of embodiment of the temperature measuring apparatus, the material of which the connection wires are composed differs from that of which the thermocouple wires are composed such that the material of which the connection wires are composed has a higher tensile strength in newton per mm². As already mentioned, in such case, the thermocouple wires as well as also the connection wires can be of different materials. Especially preferably, the connection wires are, in such case, composed of materials, which, in contrast to the materials of which the thermocouple wires are composed, are more favorably priced. The connection wires can, in such case, be of different materials or the same material.

In a form of embodiment of the temperature measuring apparatus, the connection wires form elongations of the thermocouple wires. Wherein the connection wires form elongations of the thermocouple wires and are connected to the respective ends of the thermocouple wires, respectively with the respective ends of the thermocouple wires. In such case, preferably one thermocouple wire is connected with exactly one connection wire.

In an additional form of embodiment of the temperature measuring apparatus, the first distance and the second distance along the longitudinal axis of the jacket are predetermined by the height along the longitudinal axis of the jacket, at which the connection between the thermocouple wires and the connection wires lies. The temperature measuring apparatus has thus essentially with reference to the measuring element two portions, which are formed by the first and second distances.

In an additional form of embodiment of the temperature measuring apparatus, a first of the two connection wires is connected with a first of the two thermocouple wires and a second of the two connection wires is connected with a second of the two thermocouple wires. In this way, conductor elements are formed, which contain a section composed of a thermocouple wire and a section composed of a connection wire. In the case of a single measuring element, thus a first thermocouple wire of a first material is provided, which is connected with a first connection wire of a second material. Furthermore, a second thermocouple wire is provided, which is connected with a second connection wire. The materials of which the thermocouple wires are composed differ from one another due to the measuring principle, while the connection wires are preferably both the same material. The first and second thermocouple wires have in the same way as the first and second connection wires preferably the same length. These conductor elements formed, or assembled, in such a manner can also be prefabricated and first in the case of assembling the temperature measuring apparatus can the thermocouple wires be connected with one another, such as described in the following, in order to form a measuring point.

In an additional form of embodiment of the temperature measuring apparatus, the first connection wire is connected with the first thermocouple wire at a height along the longitudinal axis of the jacket, which differs from the height along the longitudinal axis of the jacket, at which the second connection wire is connected with the second thermocouple wire.

In an additional form of embodiment of the temperature measuring apparatus, the connection wires are connected with the thermocouple wires by means of crimp connectors.

In an additional form of embodiment of the temperature measuring apparatus, the thermocouple wires are connected with one another by means of a ring- or sleeve-shaped connecting means at the measuring point, wherein the connecting means is preferably composed of the material of one of the thermocouple wires, and especially preferably of a material which differs from those of the thermocouple wires.

In a form of embodiment of the temperature measuring apparatus, the thermocouple wires are connected with the connection wires at the measuring point.

In an additional form of embodiment of the temperature measuring apparatus, the two connection wires are composed of the same material.

In an additional form of embodiment of the temperature measuring apparatus, the temperature measuring apparatus includes a plurality of measuring elements according to one of the proposed forms of embodiment, wherein the respective measuring points of measuring elements of at least a part of the measuring elements are respectively arranged at different heights along the longitudinal axis of the jacket. Such a temperature measuring apparatus is especially suitable for determining temperature at different heights along the longitudinal axis of the jacket, i.e. temperature as a function of location along the longitudinal axis of the jacket. In an additional form of embodiment of the temperature measuring apparatus, in the case of at least one part of the measuring elements, the particular lengths of the first distance and the second distance differ from one another. The measuring points of the respective measuring elements thus lie at different heights along the longitudinal axis of the jacket. In this way, the measuring elements have first and second distances, i.e. distances which are formed by the thermocouple wires and distances which are formed by the connection wires, of different lengths. Furthermore, the conductor elements formed by the thermocouple wires and the connection wires have sections of different lengths, which are composed of the thermocouple wires, respectively the connection wires.

In an additional form of embodiment of the temperature measuring apparatus, the measuring elements are combined to form a measuring insert, which is inserted into the jacket serving as protective tube. In this way, an especially compact construction of a multipoint measuring insert is achieved. A measuring insert can also be composed of only one measuring element.

In an additional form of embodiment of the temperature measuring apparatus, there is inserted into the jacket at least one formed ceramic part, which has bores for accommodating and positioning the individual measuring elements. The formed ceramic part is, in such case, preferably matched to the contour of the jacket. Furthermore, the formed ceramic part has, for example, a circularly cylindrical shape, through which the bores extend. In a form of embodiment of the temperature measuring apparatus, a number of formed ceramic parts are inserted into the jacket, wherein the ceramic elements are matched in such a manner to the measuring elements that each of the measuring points of the respective measuring elements lies, in each case, between adjoining formed ceramic parts. The formed ceramic parts can, in such case, be inserted in the jacket, for example, stacked on one another.

As regards the measuring element, the object is achieved by a measuring element for a temperature measuring apparatus according to one of the preceding forms of embodiment. The measuring element includes thus at least two thermocouple wires and at least two connection wires.

As regards the method, the object is achieved by a method for manufacturing a temperature measuring apparatus, wherein a thermocouple composed of at least two thermocouple wires is connected with connection wires, which are composed of a material, which differs from that of which the thermocouple wires are composed, and is arranged in a jacket in such a manner that the thermocouple wires extend along the longitudinal axis of the jacket a first distance at least up to a measuring point, where the thermocouple wires are connected with one another, and that the connection wires extend a second distance along the longitudinal axis of the jacket on the side of the measuring point lying opposite the thermocouple wires.

In a first method step, thus, the thermocouple wires are connected with connection wires, which are composed of materials different from that of the thermocouple wires, in order to form conductor elements. Then, these conductor elements can be inserted into a jacket, so that the thermocouple wires extend a first distance and the connection wires a second distance in the jacket. The thermocouple wires can be connected with one another either before insertion into the jacket or thereafter, in order to form a measuring point.

In a form of embodiment of the method, the measuring elements are placed in at least one formed ceramic part, which has bores for accommodating and positioning the at least one measuring element. In this form of embodiment, the measuring points are preferably formed after insertion of the measuring elements into the at least one formed ceramic part.

In an additional form of embodiment of the method, the measuring point is produced by twisting or knotting the thermocouple wires. Especially, in the case of a plurality of formed ceramic parts, into which the measuring elements are inserted, after the insertion of the measuring elements into the formed ceramic parts, in each case, a measuring point can be formed, for example, rotational displacement of the formed ceramic parts or twisting of the conductor elements.

In an additional form of embodiment of the method, the measuring point is produced by a point welding method, such as, for example, a laser-, plasma- or arc welding method.

### BRIEF DESCRIPTION OF THE DRAWINGS

The invention will now be explained in greater detail based on the appended drawing, the figures of which show as follows:

FIG. 1a is a first form of embodiment of the invention, in the case of which a pair of thermocouple wires is connected with a pair of connection wires;

FIG. 1b is a second form of embodiment of the invention, in the case of which a pair of thermocouple wires is connected with connection wires;

FIG. 2 is another form of embodiment of the invention, in the case of which a pair of thermocouple wires is connected with a pair of connection wires;

FIG. 3 is a form of embodiment of the invention, wherein the thermocouple wires and the connection wires are inserted sectionally into the formed parts; and

FIG. 4 is a form of embodiment of the invention, wherein the measuring elements formed of thermocouple wires and connection wires are arranged in a cylindrical jacket.

### DETAILED DESCRIPTION IN CONJUNCTION WITH THE DRAWINGS

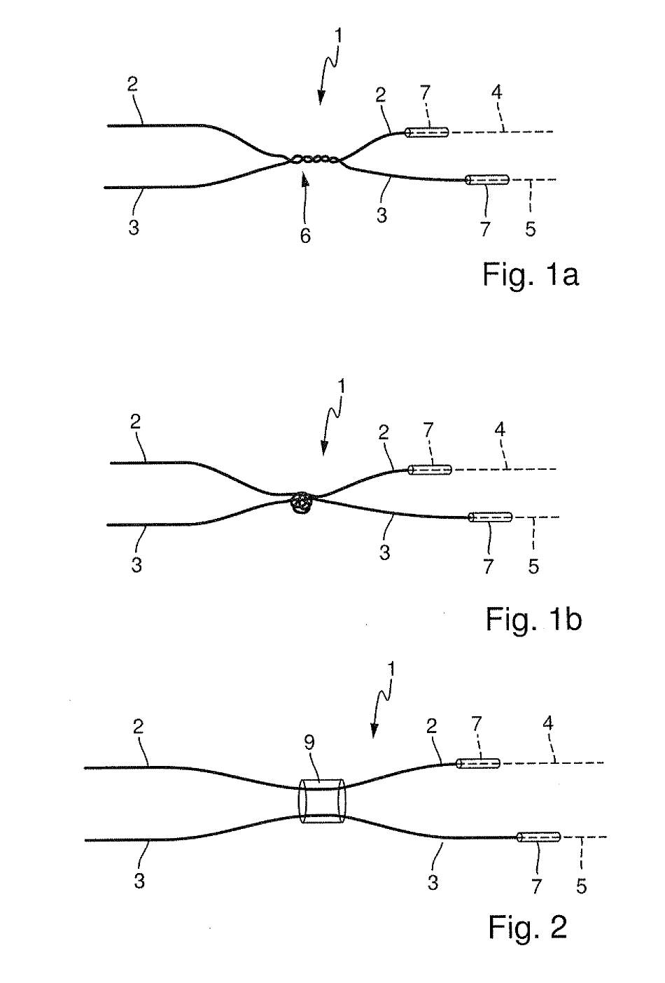

FIG. 1a shows a pair of thermocouple wires 2, 3 composed of a first thermocouple wire 2 and a second thermocouple wire 3, wherein the thermocouple wires 2, 3 are twisted together at a measuring point 6. The thermocouple wires 2, 3 extend, in such case, up to the twisting, which forms the measuring point 6 and, moreover, the sections of the thermocouple wires 2, 3 extending beyond the measuring point 6 are connected on their ends with a pair of connection wires 4, 5. The pair of connection wires 4, 5 is composed, in such case, of a first connection wire 4 and a second connection wire 5. The first connection wire 4 is connected with the first thermocouple wire 2 and the second connection wire 5 with the second thermocouple wire 3.

Materials for forming thermocouples are sufficiently known to those skilled in the art from the state of the art. Corresponding thermocouples of different types are known, for example, from DIN/EN60584-1/IEC584-1. Examples of material for the connection wires 4, 5 include, for example, copper or a mainly, or predominantly, copper and/or chromium and/or nickel containing material. Furthermore, alloys containing chromium and/or nickel and/or copper provide other options for the material of the connection wires. The fractions of the components of the materials used for the connection wires differ, however, from the portions of components used for the thermocouple wires. Furthermore, the connection wires can have as component, or components, other or other than the materials used for the thermocouple wires. Furthermore, among other things, also non-metallic materials or materials containing non-metallic components provide options for materials, of which the connection wires are composed. The connection wires are composed, for example, of the same material, but can, however, also be composed of different materials. Furthermore, the connection wires of different measuring elements can also be composed of different materials.

FIG. 1b shows essentially the same construction as FIG. 1a. However, the measuring point 6 in FIG. 1b, in contrast to FIG. 1a, is not formed by twisting the thermocouple wires 2, 3 together, but, instead, the thermocouple wires 2, 3 are knotted, in order to form a measuring point 6. As in FIG. 1a, also here, the ends of the thermocouple wires 2, 3 are connected with connection wires 4, 5. Serving as connecting means for connecting the ends of the thermocouple wires 2, 3 with the corresponding ends of the connection wires 4, 5 can be, as shown in FIG. 1a and FIG. 1b, crimp connectors 7 of suitable metal alloys and/or metal mixtures.

In order to secure the measuring point 6 durably, the twisting, respectively knotting, of the thermocouple wires 2, 3 can be made permanent by means of a suitable welding method, such as, for example, spot welding, laser welding and/or plasma welding. Furthermore, in such case, a suitable and also sufficient material supply for the following drawing process is to be provided. This material supply can be formed, for example, by an additional loop in the twisting or knotting. In this way, an especially reliable drawing process can be achieved, so that a tearing or breaking of the thermocouple wires 2, 3, respectively the connection wires 4, 5, can be avoided.

FIG. 2 shows an alternative form of embodiment of the invention in the form of a measuring element. Likewise as in FIGS. 1a and 1b, in this case also, two thermocouple wires 2, 3 are connected with two connection wires 4, 5. The measuring point 6 is, however, formed in the embodiment of FIG. 2 by means of a sleeve 9. The thermocouple wires 2, 3 are for this purpose inserted into the sleeve 9, so that the sleeve 9 forms the contact point between the two thermocouple wires 2, 3. This contact point between the thermocouple wires 2, 3 forms then also the measuring point 6. By means of spot welding, laser welding or plasma welding, the thermocouple wires 2, 3 can then be secured to the sleeve 9 or with the sleeve 9. As shown in FIG. 2, the thermocouple wires 2, 3 cannot only be inserted into the sleeve 9, but, instead, also brought through the sleeve 9, so that a section of thermocouple wires 2, 3 reaches beyond the sleeve 9. The ends of the thermocouple wires 2, 3 are then connected, for example, by means of crimp connectors 7, with the connection wires 4, 5. Sleeve 9 is composed, in such case, preferably of the material of one of the thermocouple wires 2, 3.

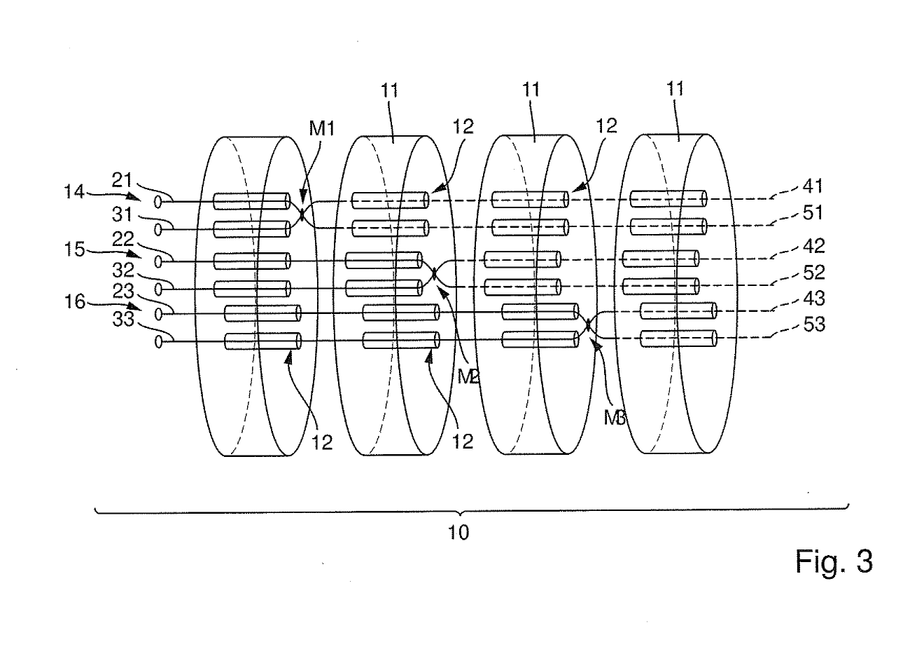

FIG. 3 shows another form of embodiment of the invention, in the case of which a plurality of measuring elements 14, 15, 16 are used, which are inserted into preferably ceramic formed parts 11.

The measuring elements 14, 15, 16 are composed, in each case, of a pair of thermocouple wires 21, 31; 22, 32; 23, 33 and a pair of connection wires 41, 51; 42, 52; 43, 53. Thermocouple wires as well as also connection wires are led through corresponding bores 12 in the formed parts 11, which are preferably of ceramic. The measuring point M1, M2, M3 of the respective pairs of thermocouple wires 21, 31; 22, 32; 23, 33 are, in such case, arranged between two formed parts 11 following one after the other. FIG. 3 shows, in such case, in each case, exactly only one measuring point 14, 15, 16 arranged between two adjoining formed parts 11. There can, however, also be a number of measuring points (not shown) provided between two sequential, formed parts. Between the free ends of the thermocouple wires 21, 31; 22, 32; 23, 33 protruding out from the formed parts 11, or, when the formed parts are inserted in the jacket, from the jacket, then thermocouple voltages referenced to the respective measuring points M1, M2, M3 can be tapped.

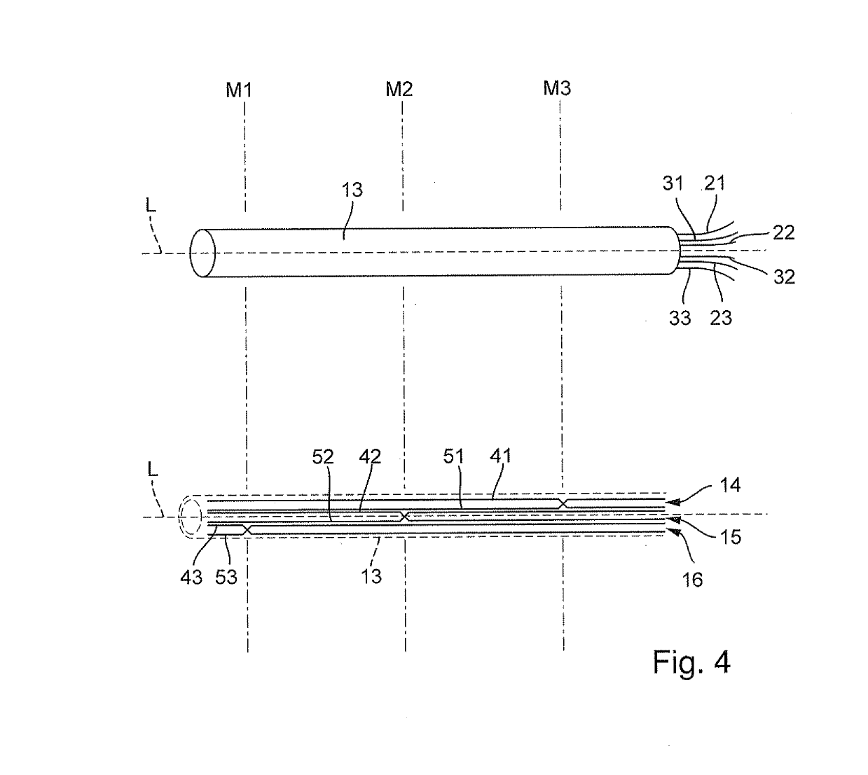

FIG. 4 shows another form of embodiment of the invention, in the case of which a number of measuring elements 14, 15, 16 are arranged in a jacket 13. The measuring points M1, M2, M3 of the measuring elements 14, 15, 16 are, in such case, located at unique positions, i.e. at unique heights along the longitudinal axis L of the jacket 13. The thermocouple wires 21, 31; 22, 32; 23, 33 extend, in such case, over a first distance along the longitudinal axis L of the jacket 13 and the connection wires 41, 51; 42, 52; 43, 53 over a second distance along the longitudinal axis L of the jacket 13. The temperature measuring apparatus 1 shown in FIG. 4 can, thus, be used for determining temperature as a function of location along the longitudinal axis L of the jacket 13, i.e. of the temperature measuring apparatus 1.

Because the connection wires 41, 51; 42, 52; 43, 53 are composed of other material than the thermocouple wires 21, 31; 22, 32; 23, 33, an especially favorable temperature measuring apparatus can be produced. The material of which the connection wires 41, 51; 42, 52; 43, 53 can be made, compared with the material of the thermocouple wires 21, 31; 22, 32; 23, 33, have an increased thermal resistance as well as also increased mechanical strength. In this way, the measuring elements and temperature measuring apparatus 1 can withstand increased mechanical loadings, such as occur in the case of the manufacturing related, drawing process. Furthermore, the material of the connection wires 41, 51; 42, 52; 43, 53 can also be a non-metallic material. The formed parts, for example, shown in FIG. 3, are, for reasons of perspicuity, not shown in FIG. 4. These can, however, be inserted into a metal tubular jacket 13 suitable for the intended purpose. The formed parts 11 have, in such case, such as stated above, bores 12, through which the thermocouple wires 21, 31; 22, 32; 23, 33, respectively the connection wires 41, 51; 42, 52; 43, 53, are led. In an embodiment, the diameter of the bores 12 can be expanded in the bore end sections facing the respective measuring points M1, M2, M3, in order to accommodate other connecting elements 9. The connecting elements 9 can, such as already stated, be eyes or sleeves. These eyes or sleeves can be composed of the material of the first thermocouple wire 21, 22, 23 or the material of the second thermocouple wire 31; 32; 33.

1. A temperature measuring apparatus, comprising:
at least one measuring element; and
a jacket, defining a longitudinal axis, in which said at least one measuring element is arranged, said measuring element includes a thermocouple, which is composed of at least two thermocouple wires, which are connected with one another at a height of a measuring point along said longitudinal axis, wherein:
said thermocouple wires extend a first distance along said longitudinal axis at least up to the measuring point;
said at least one measuring element includes, at least two connection wires, which extend a second distance on the side of the measuring point lying opposite said thermocouple wires along said longitudinal axis and are connected with the thermocouple wires, and
said two connection wires are composed of a material, which differs from that of said thermocouple wires.

2. The temperature measuring apparatus as claimed in claim 1, wherein:
said thermocouple wires serve for determining temperature; and
a voltage is tappable between the ends of said thermocouple wires corresponding to the temperature at the measuring point.

3. The temperature measuring apparatus as claimed in claim 1, wherein:
said connection wires extend on the side of the measuring point lying opposite said thermocouple wires and are preferably connected with said thermocouple wires on the side of the measuring point lying opposite said thermocouple wires.

4. The temperature measuring apparatus as claimed in claim 1, wherein:
said thermocouple wires have, in each case, a first section, which extends up to the measuring point and a second section, which extends between the measuring point and said connection wires.

5. The temperature measuring apparatus as claimed in claim 1, wherein:
the material of said connection wires have a higher tensile strength than the material of said thermocouple wires.

6. The temperature measuring apparatus as claimed in claim 1, wherein:
the material, of which said connection wires are composed, differs from that, of which said thermocouple wires are composed, such that the material, of which said connection lines are composed, has a higher tensile strength in newton per square millimeter.

7. The temperature measuring apparatus as claimed in claim 1, wherein:
said connection wires connect to the thermocouple wires and form elongations of said thermocouple wires.

8. The temperature measuring apparatus as claimed in claim 1, wherein:
the first distance and the second distance along said longitudinal axis are predetermined by the height along said longitudinal axis, at which the connection between said thermocouple wires and said connection wires lies.

9. The temperature measuring apparatus as claimed in claim 1, wherein:
a first of said two connection wires is connected with a first of said two thermocouple wires; and
a second of said two connection wires is connected with a second of said two thermocouple wires.

10. The temperature measuring apparatus as claimed in claim 1, wherein:
said first connection wire is connected with said first thermocouple wire at a height along said longitudinal axis, which differs from the height along said longitudinal axis, at which said second connection wire is connected with said second thermocouple wire.

11. The temperature measuring apparatus as claimed in claim 1, wherein:
said connection wires are connected with said thermocouple wires by means of crimp connectors.

12. The temperature measuring apparatus as claimed in claim 1, wherein:
said thermocouple wires are connected with one another by means of a ring- or sleeve-shaped connecting means, which is preferably composed of the material of one of said thermocouple wires, and especially preferably of a material, which differs from that of said thermocouple wires.

13. The temperature measuring apparatus as claimed in claim 1, wherein:
said thermocouple wires are connected with said connection wires at the measuring point.

14. The temperature measuring apparatus as claimed in claim 1, wherein:
said two connection wires are composed of the same material.

15. The temperature measuring apparatus as claimed in claim 1, wherein:
the temperature measuring apparatus includes a plurality of measuring elements;
the respective measuring points of at least a part of said measuring elements are respectively arranged at different heights along said longitudinal axis.

16. The temperature measuring apparatus as claimed in claim 1, wherein:
at least in the case of a part of said measuring elements, the respective length of said first distance and the respective length of said second distance differ from one another.

17. The temperature measuring apparatus as claimed in claim 1, wherein:
said measuring elements are combined to form a measuring insert, which is inserted into said jacket serving as a protective tube.

18. The temperature measuring apparatus as claimed in claim 1, further comprising:
at least one formed part inserted into said jacket, preferably a formed part matched to the contour of said jacket; and
said formed part has bores for accommodating and positioning said measuring elements.

19. The temperature measuring apparatus as claimed in claim 1, further comprising:
a plurality of stackable formed parts, which are insertable into said jacket; and
said formed parts are matched to said measuring elements in such a manner that each of the measuring points of the respective measuring elements lies between two adjoining formed parts.

20. A measuring element for a temperature measuring apparatus comprising:
at least one measuring element; and
a jacket, defining a longitudinal axis, in which said at least one measuring element is arranged, said measuring element includes a thermocouple, which is composed of at least two thermocouple wires, which are connected with one another at a height of a measuring point along said longitudinal axis, wherein:
said thermocouple wires extend a first distance along said longitudinal axis at least up to the measuring point; said at least one measuring element includes, at least two connection wires, which extend a second distance on the side of the measuring point lying opposite said thermocouple wires along said longitudinal axis and are connected with the thermocouple wires, and
said two connection wires are composed of a material, which differs from that of said thermocouple wires.

21. A method for manufacturing a temperature measuring apparatus, comprising the steps of:
connecting a thermocouple composed of at least two thermocouple wires with connection wires, which are composed of a material, which differs from that of which the thermocouple wires are composed; and
arranging the connection in a jacket in such a manner that the thermocouple wires extend along the longitudinal axis of the jacket a first distance at least up to a measuring point, where the thermocouple wires are connected with one another, and that the connection wires extend a second distance along the longitudinal axis of the jacket on the side of the measuring point lying opposite the thermocouple wires.

22. The method as claimed in claim 21, wherein:
the measuring elements are inserted in at least one formed part, which has bores for accommodating and positioning the at least one measuring element.

23. The method as claimed in claim 21, wherein:
the measuring point is produced by twisting or knotting the thermocouple wires.

24. The method as claimed in method 21, wherein:
the measuring point is produced by a spot welding method, or a laser-, plasma- or arc welding method.
